(19) United States
(12) Patent Application Publication
(10) Pub. No.: US 2004/0116011 A1
(43) Pub. Date: Jun. 17, 2004

(54) Floatation device

(76) Inventor: Benjamin F. Jackson, Evanston, IL (US)

Correspondence Address: Benjamin F Jackson, 2417 Lake Street, Evanston, IL, 60201, US

(21) Appl. No.: 10/317,289

(22) Filed: Dec. 13, 2002

(51) Int. Cl. B63B 9/04; B63B 35/58

(52) U.S. Cl. 441/35

(57) ABSTRACT

A plastic frame made up of lengths of plastic tubing and hollow plastic containers mounted on and releasable tied to the frame, both independently floatable. It also includes a form made up of containers and ties securing them together.

### GENERAL FIELD

The device is in the general nature of a life saver but can be used in many situations closely related to life saving.

The main principle of the device is the utilization of discarded plastic bottles that have been used principally as soft drink bottles.

The bottles are mounted in a frame, the frame also being of a plastic material. The frame is made up of pieces of tubing and connectors which include elbows and tees, the entire device thereby being made up of plastic materials, all parts having interiors that can be sealed to the exterior, thereby forming a complete floatable device.

The bottles are basically white, or transparent, and in making up the device, the interiors of the bottles are painted brilliant colors, whereby to become conspicuous as markers, in the water or on the ground near the water.

### BRIEF DESCRIPTIONS OF INDIVIDUAL FIGURES OF THE DRAWINGS

FIG. 1 is a face view of one form of frame used in the device.

FIG. 2 is a face view of a frame of alternate form relative to that of FIG. 1.

FIG. 3 is an edge view of the frame as viewed in either FIG. 1 or FIG. 2.

FIG. 4 is a sectional view of that portion of FIG. 1 surrounded by the rectangle 4, and oriented according to FIG. 1.

FIG. 5 is a side view of a discarded plastic bottle used in the device.

FIG. 6 is a sectional view of the upper portion of the plastic bottle of FIG. 5 in association with a paint spray nozzle.

FIG. 7 is a face view of the device of the invention, including the frame of FIG. 1 and a plurality of plastic bottles of FIG. 5.

FIG. 8 is a enlarged, fragmentary view taken from the device of FIG. 7 but including a tie for holding the plastic bottles in place in the device.

FIG. 9 is a view similar to that of FIG. 8 but showing a longer portion of the device and showing a plurality of ties for tying the plastic bottles.

FIG. 10 is a view of portions of two plastic bottles connected together, for use in the final device.

FIG. 11 is a view similar to FIG. 10 but showing more details, including glue for holding the caps on the bottles.

FIG. 12 is a view similar to FIG. 11 but including a further detail of a rivet or bolt holding two of the plastic bottles together.

FIG. 13 is a side view of a plurality of plastic bottles, and connector pieces forming a unit for use as a life saver or toy.

FIG. 14 is a view of one half of the device of FIG. 13 embedded in the water.

FIG. 15 is a view similar to that of FIG. 15 but embedded in dry ground.

FIG. 16 is a perspective view of a different form of floatation device.

FIG. 17 is a view taken at line 17-17 of FIG. 16.

FIG. 18 is a top view of a plurality of devices like that of FIG. 17 distributed in the water.

FIG. 19 is a side view of a device designed for and used on a dog, showing the dog in the water and the flotation device applied to it.

FIG. 20 is an end view taken from the right of FIG. 18.

FIG. 21 is a top view of FIG. 18.

### DETAILED DESCRIPTION OF THE DRAWINGS

FIGS. 1 and 2 show frames 30,32 which are very similar to each other, but differing in dimensions or proportions. The frames also are similar to the frames in FIGS. 2 and 1 respectively of my prior U.S. Pat. No. 5,911,652. The frames disclosed in that prior patent are exercise devices, or a single combination device, made up of two frames. An advantage of the device of the present invention is the possibility of using the frames as exercise devices but also provided with discarded plastic bottles for producing life saving devices, and markers.

Each frame is made up of a perimeter frame member 34 and connector members which include elbows 35 and tees 36.

The frame of FIG. 1 includes longitudinal side bars 38, 39 and a longitudinal central bar 40.

The frame also includes double cross bars 42 at each end, including outer bars and inner bars, and the central bar 40 is connected with the inner cross bars.

The frame of FIG. 2 is similar to the frame of FIG. 1 but does not include a longitudinal central bar.

In both forms of the frames, the longitudinal bars and the cross bars are referred to as linear elements and are connected together by elbows and tees respectively.

All pieces and elements of the frames thus far referred to, are made of plastic material. The bars are formed by segments of an aggregate supply of tubing, while the elbows and tees are conventional. The pieces are secured together by means of glue. All the elements of the frames are of course hollow and when the frame is fabricated as just referred to, the normal openings in the pieces are closed, and consequently the entire frame is floatable in the water.

Reference if made to FIG. 4 showing the details of the connections of the pieces. Elements of the glue are shown at 43, and it will be noted that the respective axes 44, 45, 46 intersect at points 47, 48, which provides solidity of the frame.

The frame of FIG. 2 is slightly wider than the frame of FIG. 1, enabling the latter to be inserted through the former, and positioned in planes at right angles to each other.

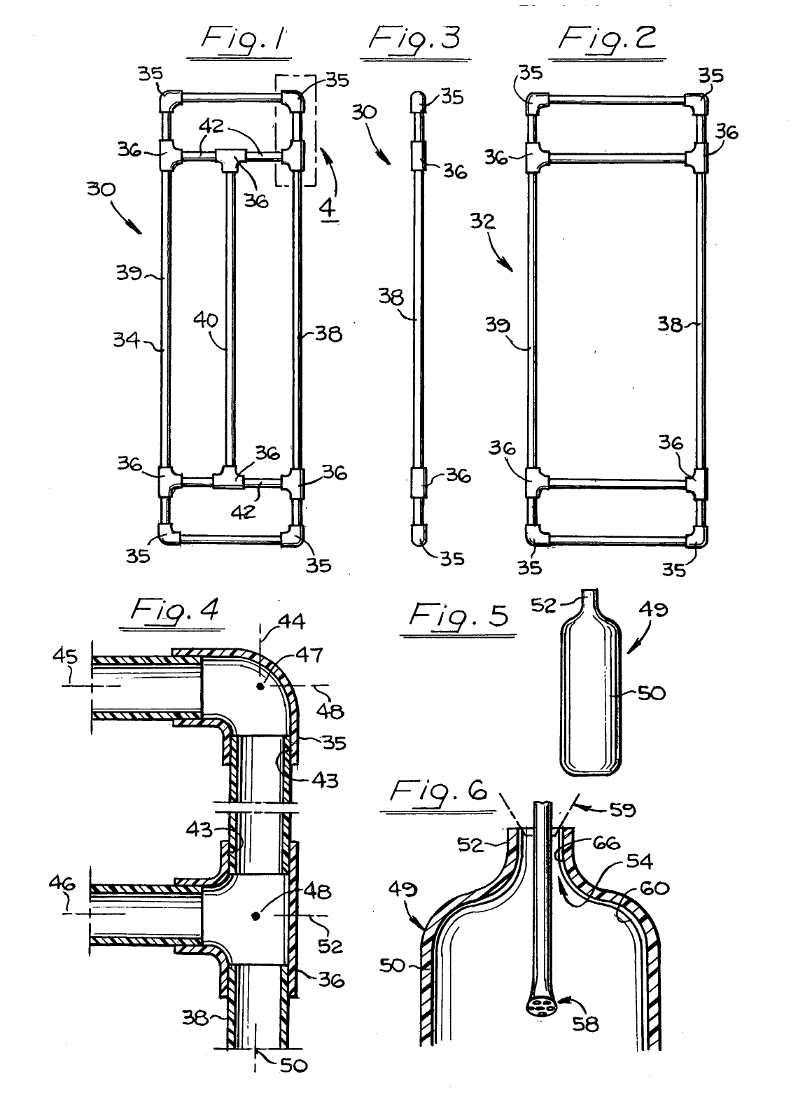

Reference is next made to FIGS. 5 and 6 showing discarded, empty soft drink bottles made of plastic. A principal feature of the invention is that the entire device is made up of such frames and discarded soft drink bottles, thereby forming a great part of the device of discarded materials, namely the bottles.

FIG. 5 shows such a bottle 49 which was originally clear or nearly so, and contains a main body portion 50 and a neck 52 of relatively small diameter. The neck defines a hole 54 (FIG. 6). The plastic of the bottle is water-tight and when the hole in the bottle is closed, the bottle is sealed and is floatable in water. As will be referred to later, the bottles are painted so as to render them distinctive. FIG. 6 indicates diagrammatically, a nozzle 58 for spraying the paint on the interior of the bottle and an alternative form of nozzle 59. It is so sprayed as to entirely cover the inner surface, at 60, on both the body and the neck.

In any case when two bottles are connected end-to-end, they form a small unit (e.g. FIG. 10) that may be used as a life preserver or an exercise device. The bottles may be of different sizes, such as a large size of 15″ in length and 4½″ in diameter, and a smaller size of 9″ in length and 2¼ in diameter. The larger size is appropriate for use by a larger person and the smaller size for a child or infirm person. They will serve as exercisers indoors, as in a chair or bed.

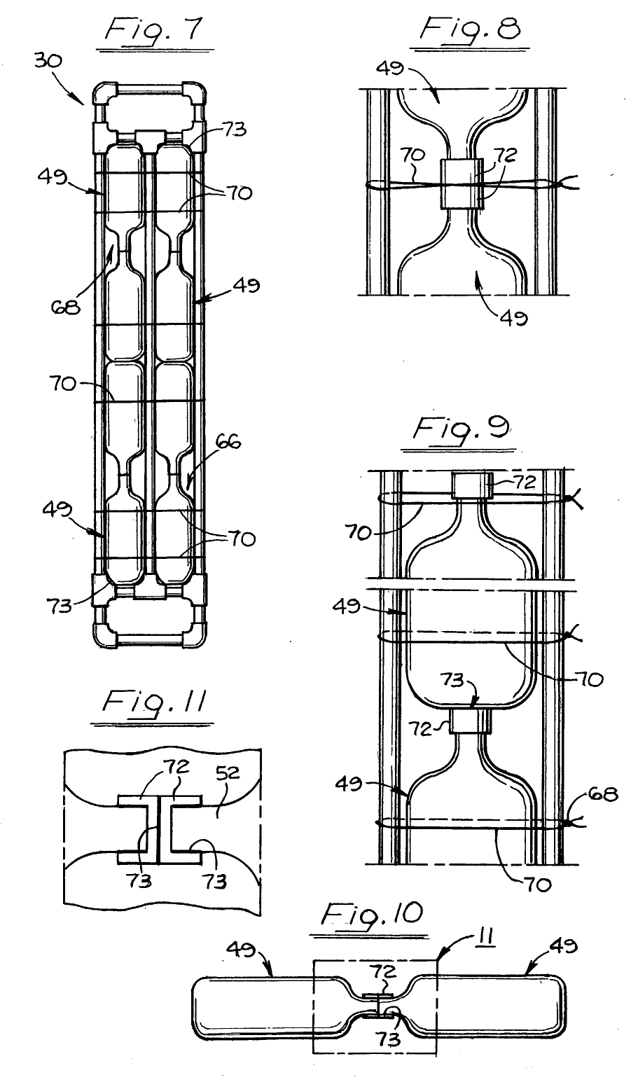

Attention is next directed to FIG. 7 showing a completed device. This figure includes the frame of FIG. 1 and a plurality of bottles mounted therein. In this frame, each of the side bars, in association with the central bar, forms a channel, the channels being identified 66, 68. A plurality of the discarded plastic bottles are mounted in each of the channels 66, 68, as shown in FIG. 7. In this position they are in engagement with the longitudinal bars, and with the inner cross bars of the frame, at the ends, and are held in place by ties 70. The bottles, as noted, when so positioned, engage the longitudinal bars of the frame, and the next adjacent ones are also in interengagement longitudinally. In this interengagement they may be positioned with the respective necks interengaging, or the bottoms of the bottles interengaging. FIG. 8 shows the neck ends of two bottles interengaged, and a tie 70 secured between those small ends and tied to the respective bars of the frame. In FIG. 8 the tie may be between the caps of the respective bottles and the caps glued together securely holding the tie therebetween. This tie thus holds the two adjacent bottles in proper position transversely, in engagement with the bars forming the longitudinal channel.

The device of FIG. 7 is a representation of how the device would be used. The entire device, as noted above, is floatable, and can be used anywhere in the water, either shallow or deep. In this form, a person can lie on it and float on the water, the bottles being of great floating capacity.

Also the device may be used as a toy by children in the water, and they can hang on it or ride on it as a life preserver.

FIG. 9 is similar to FIG. 8, but shows a plurality of plastic bottles in the frame and several ties 70 holding the respective bottles in place transversely. They are also in interengagement longitudinally, which holds the bottles in place in longitudinal direction. It will be noted also that (FIG. 7) the end bottles engage the inner cross bars at the ends of the frame at 73.

FIGS. 8 and 9 show caps 72 which may be of conventional nature, as is shown better in FIG. 10, this figure also showing glue at the spots 73 for greater securement of the bottles in position.

FIG. 11 is a view similar to FIG. 10 but showing the caps 72 in more detail, and the position of the glue between the flanges of the caps and the necks of the bottles. FIG. 12 is similar to FIG. 11 but showing additional detail of a rivet or bolt 75 for holding the caps more securely.

Attention is next directed to FIGS. 13-15. These figures show a separate unit made up of a small number of plastic bottles, interconnected, but not mounted in a frame such as in FIG. 1 or 2. In these figures (13-15) a first pair of bottles 50a, 50b are arranged longitudinally and interconnected by a tee 36. These elements make up a sub-unit. Also included is a second pair of bottles 50c, 50d arranged in longitudinal alignment and interconnected by a tee 36.

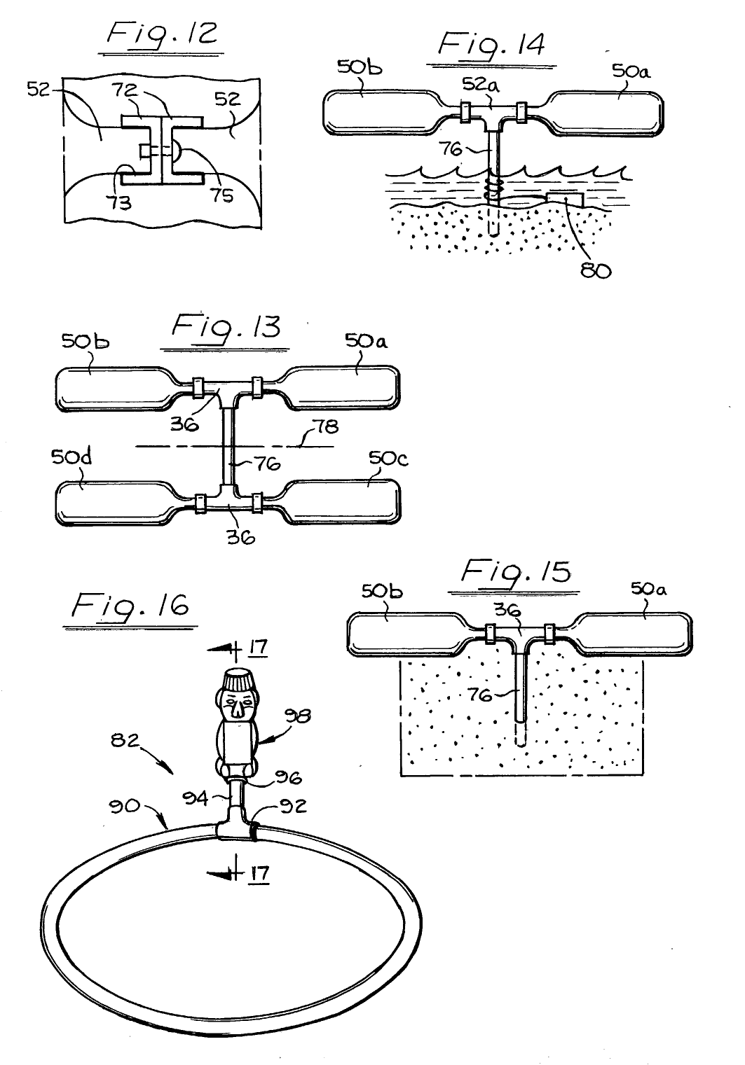

Interconnecting the tees is a central tubular linear element 76. This device as shown in FIG. 13 may be used as a marker by tying it in place or the device may be cut into two parts at the line 78 so that the two sub units may be used independently. FIG. 15 shows the upper sub-unit in place, the part of the linear element 76 forming a stake which is driven into the ground to hold the sub-unit in place. This may be done in two different ways as shown in FIGS. 14 and 15. In FIG. 14 the device is put in place in the water with the stake 76 extending downwardly into the ground, below the water. Also, instead of, or in addition to, running the stake into the ground, the stake may be used to hold the sub-unit in place where the water is deeper by means of a weight 80.

FIG. 15 shows one of the sub-units in place similar to that of FIG. 14, and in this case the stake is driven into the dry ground where the sub-unit will act as a marker on dry land. This would be particularly convenient at a beach, where the dry land is close to where the other devices, used as life savers, may be used.

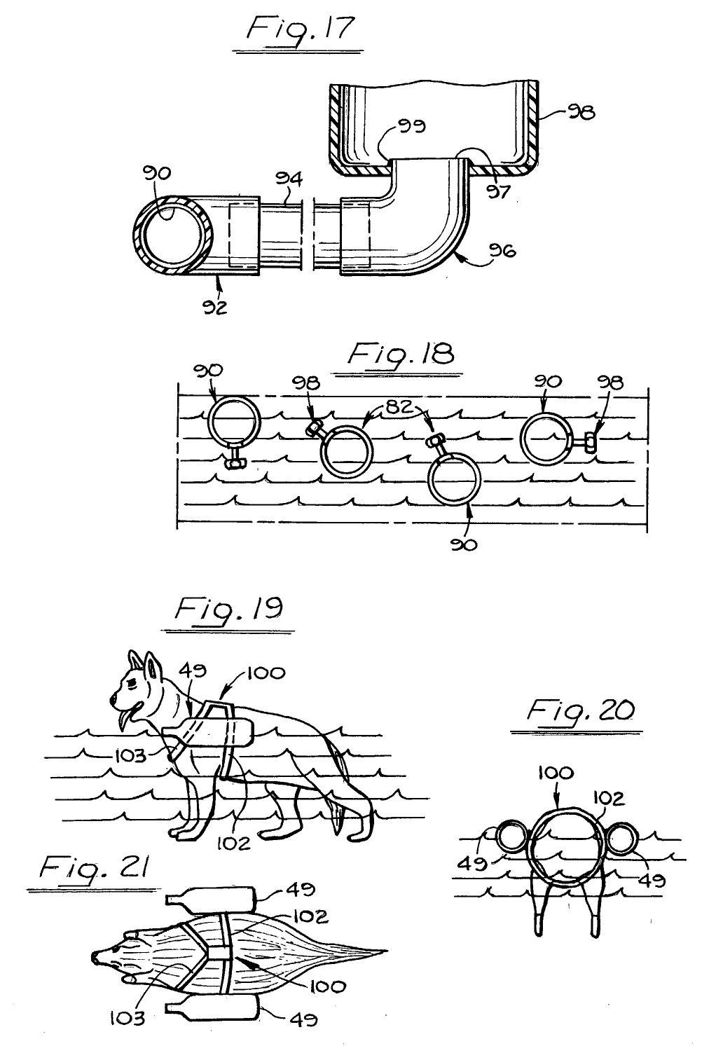

A device 82 of an entirely different appearance is shown in FIGS. 16 and 17. The device includes a circular loop 90 constituted by a single piece of plastic tubing as used in forming the linear pieces described above. The ends of the piece are brought together and a tee 92 receives the ends of the loop, and the central element 94 of the tee extends diametrically from the loop. The tee leads into an elbow 96, the elbow having its other end 97 extended through a hole in the FIG. 98. The FIG. 98 is also a discarded plastic piece, such as a bottle now on the market, normally containing honey, but in this case empty. The figure normally has the face of an animal, such as a bear, on the exterior.

The connector pieces between the loop and the figure are glued together in position, and to the FIG. 98, the latter being indicated at 99.

The entire device shown in FIGS. 16 and 17 is hollow and sealed from the exterior, and the entire device is thereby floatable. It is particularly attractive as a toy for children, but in particular being relatively small and easily movable about. Children would enjoy throwing a ball attempting to throw it through the loop, and also attempting to hit the FIG. 98 with the ball. The entire device then easily floats around and children would enjoy following it, and playing with it in the water.

FIG. 18 represents a plurality of devices of FIGS. 16. 17. in different positions, this representing the movement of the device in the water when children play with it. The easy movement of the device in the water is particularly attractive to small children because of the easy observance of movement in the water. The devices are preferably of different colors. The FIG. 98, as commercially put out, may be of blue color (for example) and the tubing of loop as acquired may be white in color, thus providing a contrast between the colors for greater attractiveness.

An entirely different kind of device but using the same general principles, is shown in FIGS. 19-21. The device of these figures enables a floatation component to be applied to a dog, for providing semi, or complete, floatation of the dog. In FIG. 19, a harness 100 includes a main body strap 102 and a second strap 103 positioned around the neck of a dog ahead of the fore legs. A pair of discarded plastic bottles 50 are mounted on the harness, one on each side of the dog, and arranged horizontally with the small end or neck end directed forwardly. The harness may be designed and proportioned to originally position the bottles at any desired height on the dog and in the action of the dog, the bottles may move slightly, upwardly or downwardly, remaining within a range of movement enabling the dog to be floated, or semi-floated at the desired depth in the water. The appearance of the dog would remain obvious at all times and would provide great enjoyment to the observer, and to the dog itself.

I claim:

1 A plastic floatation device comprising,
a frame comprising a plurality of linear lengths of tubing secured together by connecting them with connectors which include elbows and tees, by means of glue.
the linear lengths including at least two longitudional lengths parallel to each other and thereby forming at least one channel
said two linear lengths having limited transverse flexibility.
a plurality of elongated plastic bottles mounted in each channel in end-to-end, and interengaging, relationship, and with the end ones thereof engaging corresponding linear lengths against longitudinal displacement, and
ties that are individually and manually manipulable surrounding each bottle and the related two linear lengths, drawing the flexible linear lengths into firm engagement with the corresponding bottles, and
all of the linear lengths and the bottles being empty and sealed against water.

2. A plastic floatation device according to claim 1 wherein,
the bottles are discarded plastic.

3. A plastic flotation device according to claim 1 wherein,
the frame, the bottles, and the ties, make up the entire device, except for the glue utilized for securing various elements together.

4. A plastic flotation device according to claim 1 wherein,
all of the linear lengths, and each individually, are of uniform construction throughout their lengths.

5. A plastic flotation device according to claim 1 wherein,
the frame is elongated having a plurality of transversely spaced, elongated lengths forming a plurality of channels, one each between each two next-adjacent lengths.
a plurality of bottles in each of the channels and tied therein, and
the plastic containers being capable of floating the entire device on water.

6. A plastic floatation device comprising
a plurality of elongated floatable bottles, connected together at an inner end of each, at a central point from which the bottles radiate and together form a star shape, and
the plastic bottles together being capable of floating the entire device on water.

7. A plastic floatation device according to claim 6 wherein,
the inner surfaces of the bottles are covered with a layer of brilliant paint, and
the material of which the bottles are made is sufficiently translucent to transmit the color of the paint to the exterior.

8. A floatable plastic device according to claim 6,
wherein it includes a main longitudinal axis, a plurality of pairs of elongated plastic bottles,
those plastic bottles in each pair being positioned end-to-end on a transverse axis,
the pairs of plastic bottles being spaced apart along the main axis
each plastic bottle including a small neck opening and a cap sealing that opening,
the plastic bottles of each pair being secured together with their small necks directed toward each other but spaced apart, and
connectors interconnecting the pairs of bottles.

9. A plastic floatable device according to claim 8, wherein,
the connectors include a central longitudinal linear length,
the linear length being adaptable to being cut through at a central point to form pair of spikes, one on each pair of bottles, and
the spikes being adapted to be driven into the ground for mounting the pairs above the ground to form conspicuous visual markers.

10. A plastic floatable device comprising,
a frame floatable on water, and
a figure of an animal on the frame and extending entirely above the frame when the frame is floating,
the frame being capable of sustaining the entire device in floating condition.

11. A floatation device according to claim 10 wherein,
the frame is constituted by a circular ring of tubular construction, and
the figure is constituted by an empty plastic bottle designed for containing an edible food product.

12. A plastic floatation device according to claim 10 and comprising,
a floatable empty bottle, and a
frame including an elongated tubular member having its ends connected to the bottle and thereby forming a loop of the frame,
the plastic container and frame being floatable in water, and both being sealed against passage of water thereinto.

13. A floatation device according to claim 1 wherein,
the device normally lies in a space between two nearly-flat planes spaced apart and
the plastic bottles occupy said space between the nearly-flat planes
the thickness of the bottles substantially determining the thickness of the device.

14. A floatable device according to claim 3 and including a harness applicable to the body of a dog, and
discarded bottles mounted on the harness, one on each side of the dog.
